(19) United States
(12) Patent Application Publication
(10) Pub. No.: US 2010/0019747 A1
(43) Pub. Date: Jan. 28, 2010

(54) LOW DROPOUT REGULATOR

(75) Inventors: SHUN HAU KAO, HSINCHU (TW); MAO CHUAN CHIEN, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED ANALOG TECHNOLOGY, INC., HSINCHU (TW)

(21) Appl. No.: 12/235,877

(22) Filed: Sep. 23, 2008

(30) Foreign Application Priority Data
Jul. 24, 2008 (TW) 097128059

(51) Int. Cl. G05F 1/56

(52) U.S. Cl. 323/274

(57) ABSTRACT

A low dropout regulator comprises a depletion mode NMOS transistor, a switch and an error amplifier. The source electrode of the depletion type NMOS transistor is coupled to a feedback circuit. The switch, controlled by a control signal, connects a supply voltage to the drain electrode of the depletion mode NMOS transistor. The non-inverting input terminal of the error amplifier is coupled to a reference voltage. The output terminal of the error amplifier is coupled to the gate electrode of the depletion mode NMOS transistor. The inverting input terminal of the error amplifier is coupled to the feedback circuit.

### BACKGROUND OF THE INVENTION

1. Field of the Invention

The present invention relates to a regulator, and more particularly, to a low dropout regulator.

2. Description of the Related Art

A low dropout regulator, one kind of linear regulator, provides an output voltage slightly lower than its input voltage. FIG. 1 shows a conventional low dropout regulator. The low dropout regulator 100, coupled to a load circuit 160, comprises a PMOS transistor 110, an error amplifier 120 and resistors 130 and 140. The PMOS transistor 110 is a power MOS transistor with its source electrode coupled to a supply voltage, its drain electrode coupled to the common node of a capacitor 150 and the load circuit 160, and its gate electrode coupled to the output terminal of the error amplifier 120. One end of the resistor 130 is coupled to the drain electrode of the PMOS transistor 110, and the other end is coupled to the non-inverting terminal of the error amplifier 120. One end of the resistor 140 is coupled to the non-inverting terminal of the error amplifier 120, and the other end is grounded. The inverting terminal of the error amplifier 120 is coupled to a bandgap voltage.

As shown in FIG. 1, the error amplifier 120 controls the operation of the PMOS transistor 110 by comparing the feedback signal from its non-inverting terminal to the bandgap voltage from its inverting terminal. When the PMOS transistor 110 is activated, it provides the load circuit 160 an output voltage Vₒᵤₜ, which equals the supply voltage minus the drain-to-gate voltage of the PMOS transistor 110. Since the drain-to-gate voltage of the PMOS transistor 110 is relatively low, the output voltage provided by the low dropout regulator 100 is slightly lower than the supply voltage. If the load circuit 160 is a light load, the PMOS transistor 110 operates in saturation region, and the equivalent resistance at the output terminal of the PMOS transistor 110 is large. However, if the load circuit 160 is a heavy load, the PMOS transistor 110 operates in triode region, and the equivalent resistance at the output terminal of the PMOS transistor 110 is small. At such point, the dominant pole at the Bode plot of the low dropout regulator 100 shifts to a higher frequency, and the stability of the low dropout regulator 100 is compromised. Therefore, when the load circuit 160 becomes a heavy load, the low dropout regulator 100 requires an additional current flowing through to maintain its stability. On the other hand, since the vibration of the supply voltage has a direct influence on the drain-to-source voltage of the PMOS transistor 110, and the drain-to-source voltage of the PMOS transistor 110 has a direct influence on the output voltage Vₒᵤₜ of the low dropout regulator 100, the low dropout regulator 100 exhibits a lower power supply rejection ratio (PSRR) when operating in DC mode. In addition, when the load circuit 160 becomes a light load, the dominant pole at the Bode plot of the low dropout regulator 100 is large, so the PSRR bandwidth of the low dropout regulator 100 is narrow. In other words, the low dropout regulator 100 only maintains a fixed PSRR if the frequency of the supply voltage lies from DC to a certain low frequency, and the PSRR of the low dropout regulator 100 drops accordingly if the frequency of the supply voltage exceeds the certain low frequency.

FIG. 2 shows another conventional low dropout regulator. The low dropout regulator 200, coupled to a load circuit 260, comprises an NMOS transistor 210, an error amplifier 220 and resistors 230 and 240. The NMOS transistor 210 is a power MOS transistor with its drain electrode coupled to a supply voltage, its source electrode coupled to the common node of a capacitor 250 and the load circuit 260, and its gate electrode coupled to the output terminal of the error amplifier 220. One end of the resistor 230 is coupled to the source electrode of the NMOS transistor 210, and the other end is coupled to the inverting terminal of the error amplifier 220. One end of the resistor 240 is coupled to the inverting terminal of the error amplifier 220, and the other end is grounded. The non-inverting terminal of the error amplifier 220 is coupled to a bandgap voltage.

As shown in FIG. 2, the error amplifier 220 controls the operation of the NMOS transistor 210 by comparing the feedback signal from its inverting terminal to the bandgap voltage from its non-inverting terminal. Comparing to the low dropout regulator 100, it is clear that since the equivalent resistance at the output terminal of the NMOS transistor 210 is approximately equal to the reciprocal of the conductance of the NMOS transistor 210, the dominant pole of the NMOS transistor 210 remains at high frequency whether the load circuit 260 is a heavy load or not. Therefore, the low dropout regulator 200 does not require an additional current flowing through when the load circuit 260 is a heavy load. On the other hand, since the current flowing through the NMOS transistor 210 depends on the gate-to-source voltage of the NMOS transistor 210, which only shifts slightly with the vibration of the supply voltage, the low dropout regulator 200 exhibits a better PSRR compared to the low dropout regulator 100. In addition, since the frequency of the dominant pole of the low dropout regulator 200 is much higher, the PSRR bandwidth of the low dropout regulator 200 is much wider. Moreover, since the NMOS transistor 210 exhibits a better current conducting ability than the PMOS transistor 110, the low dropout regulator 200 can be implemented on a much smaller chip than the low dropout regulator 100. However, since the threshold voltage of the NMOS transistor 210 is much higher than that of the PMOS transistor 110, the voltage dropout of the low dropout regulator 200 is much higher than that of the low dropout regulator 100.

In view of the drawbacks of the aforesaid prior art, there is a need to design a low dropout regulator, which not only exhibits no drawbacks of the aforesaid prior art, but also exhibits the advantages of both the aforesaid prior arts, such that the stability and PSRR thereof are significantly improved.

### SUMMARY OF THE INVENTION

The low dropout regulator according to one embodiment of the present invention comprises a depletion mode NMOS transistor, a switch and an error amplifier. The source electrode of the depletion mode NMOS transistor is coupled to a feedback circuit. The switch is controlled by a control signal and connects a supply voltage to the drain electrode of the depletion mode NMOS transistor. The non-inverting input terminal of the error amplifier is coupled to a reference voltage. The inverting input terminal of the error amplifier is coupled to the feedback circuit. The output terminal of the error amplifier is coupled to the gate electrode of the depletion mode NMOS transistor.

The low dropout regulator according to another embodiment of the present invention comprises a depletion mode NMOS transistor, a PMOS transistor, a feedback circuit, a zero compensation circuit and an error amplifier. The source electrode of the PMOS transistor is coupled to a supply voltage. The drain electrode of the PMOS transistor is coupled to the drain electrode of the depletion mode NMOS transistor. The feedback circuit is coupled to the source electrode of the depletion mode NMOS transistor. The input terminal of the zero compensation circuit is coupled to the feedback circuit. The non-inverting input terminal of the error amplifier is coupled to a reference voltage. The inverting input terminal of the error amplifier is coupled to the output terminal of the zero compensation circuit. The output terminal of the error amplifier is coupled to the gate electrode of the depletion mode NMOS transistor.

### BRIEF DESCRIPTION OF THE DRAWINGS

The objectives and advantages of the present invention will become apparent upon reading the following description and upon referring to the accompanying drawings of which:

FIG. 1 shows a conventional low dropout regulator;

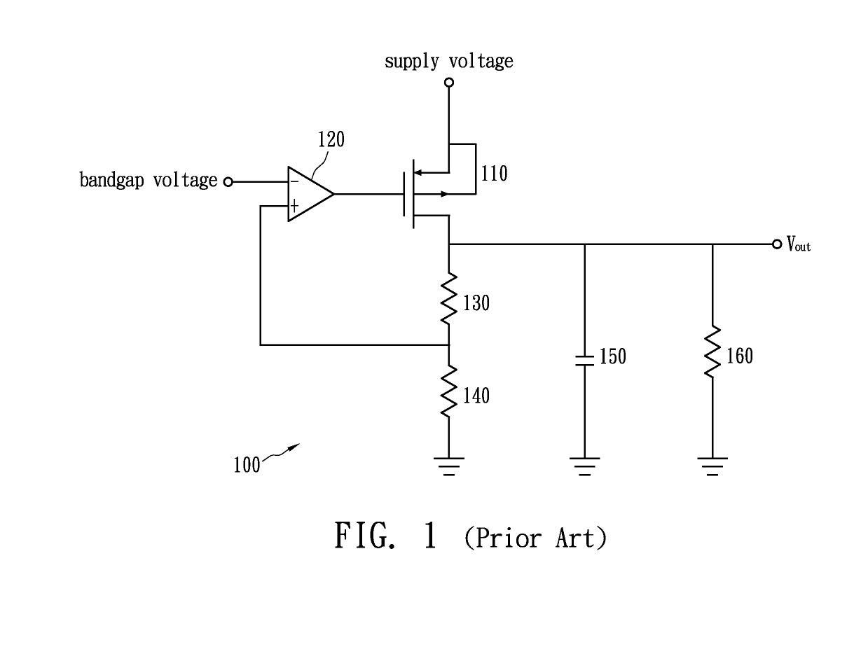

FIG. 2 shows another conventional low dropout regulator;

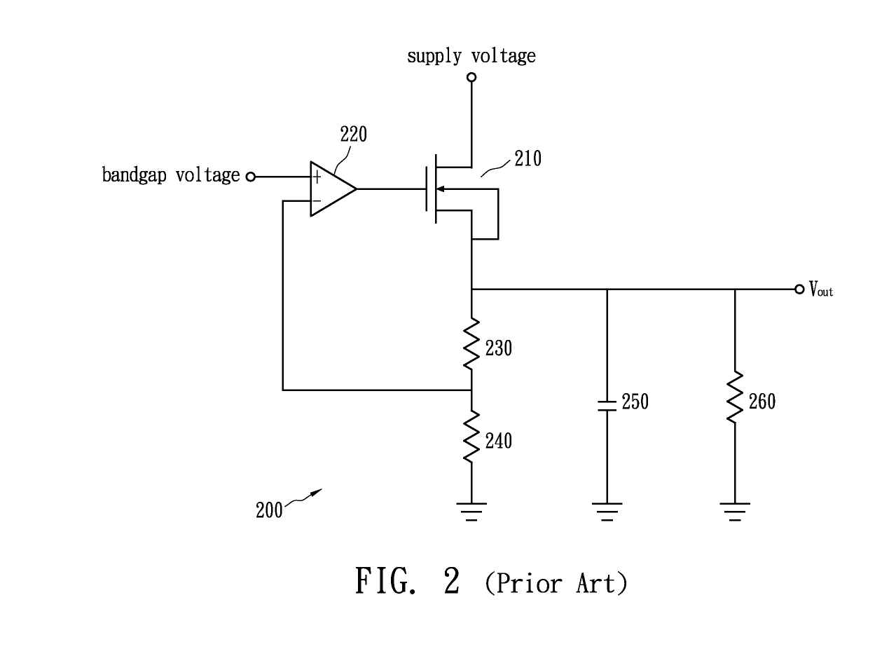

FIG. 3 shows a block diagram of the low dropout regulator according to one embodiment of the present invention; and

FIG. 4 shows a block diagram of the low dropout regulator according to another embodiment of the present invention.

### DETAILED DESCRIPTION OF THE INVENTION

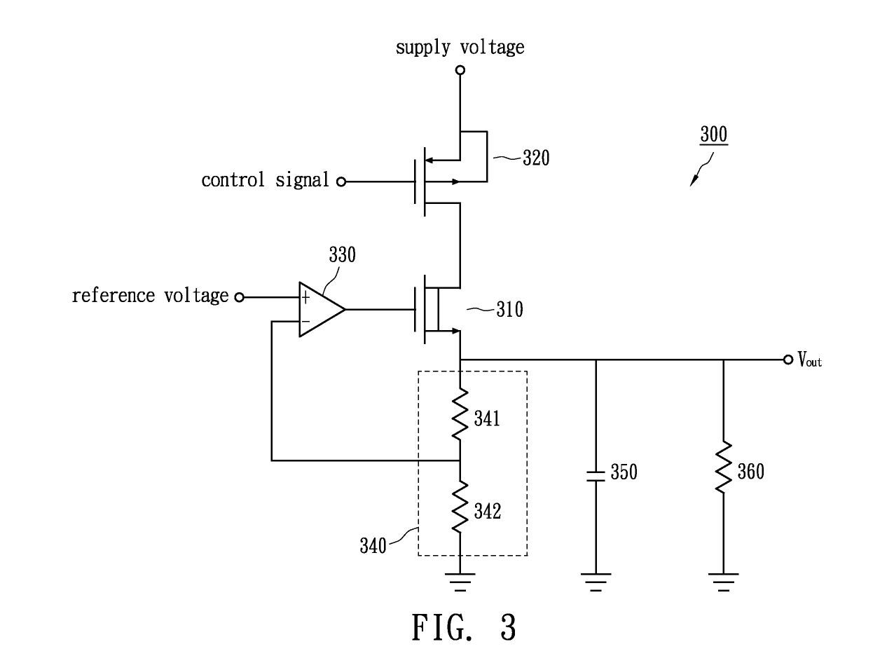

FIG. 3 shows a block diagram of the low dropout regulator according to one embodiment of the present invention. The low dropout regulator 300, coupled to a feedback circuit 340 and a load circuit 360, comprises a depletion mode NMOS transistor 310, a switch 320 and an error amplifier 330. The depletion mode NMOS transistor 310 is a power MOS transistor with its drain electrode coupled to the switch 320, its source electrode coupled to a capacitor 350, and its gate electrode coupled to the output terminal of the error amplifier 330. The switch 320 is a PMOS transistor with its source electrode coupled to a supply voltage, its drain electrode coupled to the drain electrode of the depletion mode NMOS transistor 310, and its gate electrode coupled to a control signal. The feedback circuit 340 comprises resistors 341 and 342. One end of the resistor 341 is coupled to the source electrode of the depletion mode NMOS transistor 310, and the other end is coupled to the inverting input terminal of the error amplifier 330. The resistor 342 connects the inverting input terminal of the error amplifier 330 to ground. The non-inverting input terminal of the error amplifier 330 is coupled to a reference voltage, which is a bandgap voltage.

As shown in FIG. 3, the switch 320 connects the supply voltage to the depletion mode NMOS transistor 310. The error amplifier 330 controls the operation of the depletion mode NMOS transistor 310 by comparing the feedback signal from its inverting terminal to the bandgap voltage from its non-inverting terminal, such that the depletion mode NMOS transistor 310 outputs a low dropout voltage Vₒᵤₜ. Since the equivalent resistance at the output terminal of the depletion mode NMOS transistor 310 is approximately equal to the reciprocal of the conductance of the depletion mode NMOS transistor 310, the dominant pole of the depletion mode NMOS transistor 310 remains at high frequency whether the load circuit 360 is a heavy load or not. Therefore, the low dropout regulator 300 does not require an additional current flowing through when the load circuit 360 is a heavy load. In addition, since the current flowing through the depletion mode NMOS transistor 310 depends on the gate-to-source voltage of the depletion mode NMOS transistor 310, which only shifts slightly with the vibration of the supply voltage, the low dropout regulator 300 exhibits a better PSRR than the low dropout regulator 100. Moreover, since the frequency of the dominant pole of the low dropout regulator 300 is much higher than the low dropout regulator 100, the PSRR bandwidth of the low dropout regulator 300 is much wider. On the other hand, the switch 320 is a PMOS transistor. When the control signal at the gate electrodes of the switch 320 is at a low voltage level, a large current is conducted flowing through the depletion mode NMOS transistor 310. Therefore, the switch 320 requires less chip space than the PMOS transistor 110. In addition, since the depletion mode NMOS transistor 310 exhibits a better current conducting ability than the NMOS transistor 210, it also requires less chip space than the NMOS transistor 210. Therefore, the area of the switch 320 and the depletion mode NMOS transistor 310 combined is approximately equal to the area of the NMOS transistor 210 or even smaller. Moreover, since the dropout voltage of the low dropout regulator 300 is approximately equal to the summation of the drain-to-source voltage of the switch 320, which is approximately the drain-to-source voltage of the PMOS transistor 110, and the threshold voltage of the depletion mode NMOS transistor 310, which is approximately zero volts, the low dropout regulator 300 exhibits a relatively low dropout voltage.

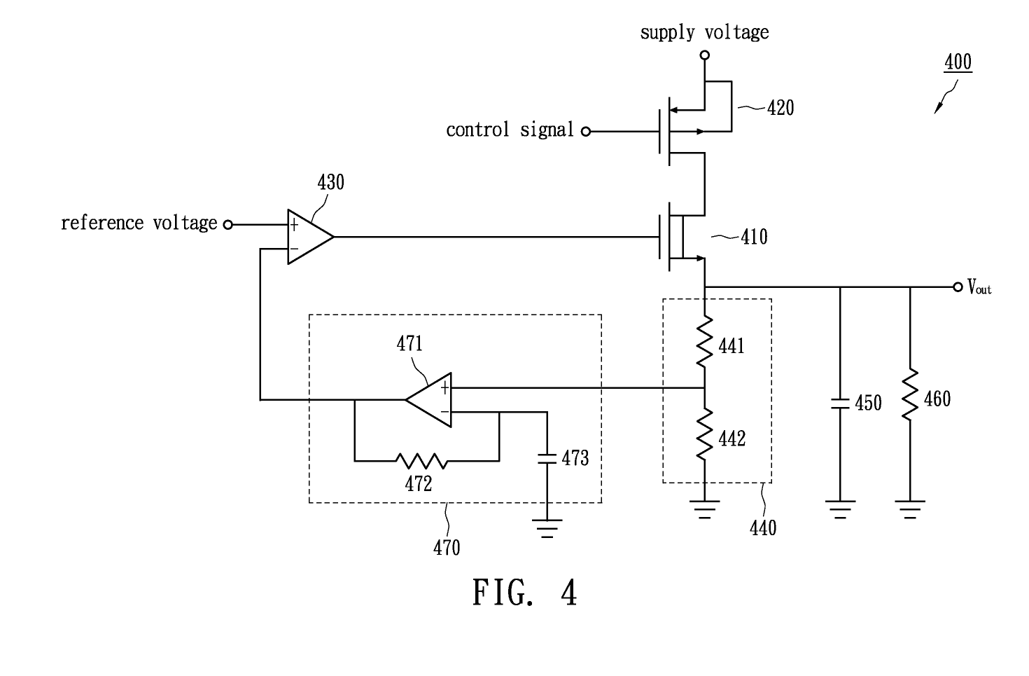

FIG. 4 shows a block diagram of the low dropout regulator according to another embodiment of the present invention. The low dropout regulator 400, coupled to a feedback circuit 440 and a load circuit 460, comprises a depletion mode NMOS transistor 410, a PMOS transistor 420, an error amplifier 430 and a zero compensation circuit 470. The depletion mode NMOS transistor 410 is a power MOS transistor with its drain electrode coupled to the drain electrode of the PMOS transistor 420, its source electrode coupled to a capacitor 450, and its gate electrode coupled to the output terminal of the error amplifier 430. The source electrode of the PMOS transistor 420 is coupled to a supply voltage. The gate electrode of the PMOS transistor 420 is coupled to a control signal. The feedback circuit 440 comprises resistors 441 and 442. One end of the resistor 441 is coupled to the source electrode of the depletion mode NMOS transistor 310, and the other end is coupled to the input terminal of the zero compensation circuit 470. The resistor 442 connects the input terminal of the zero compensation circuit 470 to ground. The non-inverting input terminal of the error amplifier 430 is coupled to a reference voltage, which is a bandgap voltage. The output terminal of the zero compensation circuit 470, coupled to the inverting input terminal of the error amplifier 430, comprises a differential amplifier 471, a resistor 472 and a capacitor 473. The non-inverting input terminal of differential amplifier 471 is the input terminal of the zero compensation circuit 470. The output terminal of the differential amplifier 471 is the output terminal of the zero compensation circuit 470. The resistor 472 is connected between the inverting input terminal and the output terminal of the differential amplifier 471. The capacitor 473 connects the inverting input terminal of the differential amplifier 471 to ground.

As shown in FIG. 4, the low dropout regulator 400 exhibits all the advantages of the low dropout regulator 300. Moreover, the addition of the zero compensation circuit 470 improves the stability of the low dropout regulator 400 such that the gain of the error amplifier 430 can be enhanced as well. Therefore, the PSRR gain of the low dropout regulator 300 is enhanced accordingly.

In conclusion, the low dropout regulators according to the embodiments of the present invention require no additional current flowing through when the load circuit thereof is a heavy load, exhibit better PSRR gain and bandwidth, require smaller chip size, and have lower dropout voltage. Moreover, the addition of the zero compensation circuit improves the stability of the low dropout regulator such that the PSRR gain of the low dropout regulators according to the embodiments of the present invention can be enhanced.

The above-described embodiments of the present invention are intended to be illustrative only. Those skilled in the art may devise numerous alternative embodiments without departing from the scope of the following claims.

What is claimed is:

1. A low dropout regulator, comprising:
a depletion mode NMOS transistor with its source electrode coupled to a feedback circuit;
a switch controlled by a control signal, the switch connecting a supply voltage to the drain electrode of the depletion mode NMOS transistor; and
an error amplifier with its non-inverting input terminal coupled to a reference voltage, with its inverting input terminal coupled to the feedback circuit, and with its output terminal coupled to the gate electrode of the depletion mode NMOS transistor.

2. The low dropout regulator of claim 1, wherein the feedback circuit comprises:
a first resistor with one end coupled to the source electrode of the depletion mode NMOS transistor; and
a second resistor with one end coupled to a common node of the other end of the first resistor and an inverting input terminal of the error amplifier, and the other end of the second resistor being grounded.

3. The low dropout regulator of claim 1, further comprising a capacitor coupled to the source electrode of the depletion mode NMOS transistor.

4. The low dropout regulator of claim 1, wherein the depletion mode NMOS transistor is a power MOS transistor.

5. The low dropout regulator of claim 1, wherein the reference voltage is a bandgap voltage.

6. The low dropout regulator of claim 1, wherein the switch is a PMOS transistor with its source electrode coupled to the supply voltage, with its gate electrode coupled to the control signal, and with its drain electrode coupled to the drain electrode of the depletion mode NMOS transistor.

7. A low dropout regulator, comprising:
a depletion mode NMOS transistor with its source electrode coupled to a feedback circuit;
a PMOS transistor with its source electrode coupled to a supply voltage, with its gate electrode coupled to a control signal, and with its drain electrode coupled to the drain electrode of the depletion mode NMOS transistor;
a zero compensation circuit with its input terminal coupled to the feedback circuit; and
an error amplifier with its non-inverting input terminal coupled to a reference voltage, with its inverting input terminal coupled to the output terminal of the zero compensation circuit, and with its output terminal coupled to the gate electrode of the depletion mode NMOS transistor.

8. The low dropout regulator of claim 7, wherein the zero compensation circuit comprises:
a differential amplifier with its non-inverting input terminal coupled to the feedback circuit, and with its output terminal coupled to the inverting input terminal of the error amplifier;
a resistor disposed between the inverting input and output terminals of the differential amplifier; and
a capacitor coupled to the inverting input terminal of the differential amplifier.

9. The low dropout regulator of claim 7, wherein the feedback circuit comprises:
a first resistor with one end coupled to the source electrode of the depletion mode NMOS transistor; and
a second resistor with one end coupled to a common node of the other end of the first resistor and the input terminal of the zero compensation circuit, and the other end of the second resistor being grounded.

10. The low dropout regulator of claim 7, further comprising a capacitor coupled to the source electrode of the depletion mode NMOS transistor.

11. The low dropout regulator of claim 7, wherein the depletion mode NMOS transistor is a power MOS transistor.

12. The low dropout regulator of claim 7, wherein the reference voltage is a bandgap voltage.

13. A low dropout regulator, comprising:
a depletion mode NMOS transistor;
a PMOS transistor with its source electrode coupled to a supply voltage, with its gate electrode coupled to a control signal, and with its drain electrode coupled to the drain electrode of the depletion mode NMOS transistor;
a feedback circuit coupled to the source electrode of the depletion mode NMOS transistor;
a zero compensation circuit with its input terminal coupled to the feedback circuit; and
an error amplifier with its non-inverting input terminal coupled to a reference voltage, with its inverting input terminal coupled to the output terminal of the zero compensation circuit, and with its output terminal coupled to the gate electrode of the depletion mode NMOS transistor.

14. The low dropout regulator of claim 13, wherein the zero compensation circuit comprises:
a differential amplifier with its non-inverting input terminal coupled to the feedback circuit, and with its output terminal coupled to the inverting input terminal of the error amplifier;
a resistor disposed between the inverting input and output terminals of the differential amplifier; and
a capacitor coupled to the inverting input terminal of the differential amplifier.

15. The low dropout regulator of claim 13, wherein the feedback circuit comprises:
a first resistor with one end coupled to the source electrode of the depletion mode NMOS transistor; and
a second resistor with one end coupled to a common node of the other end of the first resistor and the input terminal of the zero compensation circuit, and the other end of the second resistor being grounded.

16. The low dropout regulator of claim 13, further comprising a capacitor coupled to the source electrode of the depletion mode NMOS transistor.

17. The low dropout regulator of claim 13, wherein the depletion mode NMOS transistor is a power MOS transistor.

18. The low dropout regulator of claim 13, wherein the reference voltage is a bandgap voltage.
